(19) United States
(12) Patent Application Publication
(10) Pub. No.: US 2012/0007363 A1
(43) Pub. Date: Jan. 12, 2012

(54) APPARATUS FOR GENERATING ELECTRIC POWER USING WATER WAVE ENERGY

(76) Inventor: JUNE-CHI WANG, TAICHUNG CITY (TW)

(21) Appl. No.: 13/010,862

(22) Filed: Jan. 21, 2011

(30) Foreign Application Priority Data
Jul. 6, 2010 (CN) 201010226336.1

(51) Int. Cl. F03B 13/20

(52) U.S. Cl. 290/53

(57) ABSTRACT

An apparatus for generating electric power comprises an electric generating device mounted on a main frame and including a transmission unit coupled to a pivot rod of a float-mounting frame of a float unit, and a generator coupled to an accelerating unit. The float unit includes two floats connected to the float-mounting frame and riding on a water surface such that the pivot rod is rotatable relative to the main frame in response to water wave front action to generate a bi-directional mechanical rotary power output corresponding to water wave energy. The transmission unit outputs a single directional mechanical rotary power output to the accelerating unit based on the bi-directional mechanical rotary power output. The accelerating unit accelerates a rotational speed of a drive shaft of the generator such that the generator converts rotary power corresponding to the rotational speed of the drive shaft into electric power.

### BACKGROUND OF THE INVENTION

1. Field of the Invention

The invention relates to an apparatus for generating electric power using water wave energy.

2. Description of the Related Art

A conventional apparatus for converting ocean wave energy into electric power disclosed in Taiwanese Patent Application No. 95222759 includes a float riding on an ocean surface, and a turbine unit coupled to a generator. A gas turbine of the turbine unit is driven by air flows generated by a piston in response to upward movement of the float to rotate so as to output a mechanical rotary power output to the generator. The generator converts the mechanical rotary output into electric power.

However, in the aforesaid conventional apparatus, a one-way valve is mounted in each air inlet for preventing generation of a reverse air flow in the turbine unit during downward movement of the float. As a result, the conventional apparatus is unable to generate electric power during downward movement of the float. Therefore, the conventional apparatus has a low electric generation efficiency. Furthermore, since the conventional apparatus includes a main frame that must be anchored to a fixed position, such as the bottom of the sea, it cannot be used in a deep-water area of the sea and cannot be mounted on a moving ship.

### SUMMARY OF THE INVENTION

Therefore, the object of the present invention is to provide an apparatus for generating electric power from water wave energy that can overcome the aforesaid drawbacks of the prior art.

According to the present invention, there is provided an apparatus for generating electric power using water wave energy. The apparatus comprises:

a frame unit including a main frame; and

at least one electric generating device mounted on the main frame of the frame unit, the electric generating device including
at least one float unit mounted pivotally on the main frame, and including
   a float-mounting frame including a pivot rod connected pivotally to the main frame and extending in a first direction, and
   a pair of floats opposite to each other in a second direction transverse to the first direction, connected to the float-mounting frame, and adapted to ride on a water surface such that the pivot rod is rotatable relative to the main frame in response to water wave front action to generate a bidirectional mechanical rotary power output corresponding to water wave energy,
at least one transmission unit mounted on the main frame, coupled to the pivot rod, receiving the bidirectional mechanical rotary power output generated by the pivot rod, and outputting a single directional mechanical rotary power output based on the bidirectional mechanical rotary power output received thereby,
a generator mounting on the main frame and having a drive shaft,
an accelerating unit mounted on the main frame and coupled between the transmission unit and the drive shaft of the generator, the accelerating unit receiving the single directional mechanical rotary power output from the transmission unit to accelerate a rotational speed of the drive shaft of the generator such that the generator converts rotary power corresponding to the rotational speed of the drive shaft into electric power.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of an apparatus for generating electric power using water wave energy according to the present invention;

FIG. 2 is a fragmentary perspective view showing the first preferred embodiment;

FIG. 3 is a fragmentary schematic side view showing the first preferred embodiment;

FIGS. 4 and 5 are schematic front views showing the first preferred embodiment when in a state of use;

FIG. 6 is a perspective view showing the second preferred embodiment of an apparatus for generating electric power using water wave energy according to the present invention;

FIG. 7 is a fragmentary perspective view showing the second preferred embodiment;

FIG. 8 is a perspective view showing the third preferred embodiment of an apparatus for generating electric power using water wave energy according to the present invention;

FIG. 9 is a fragmentary perspective view showing the third preferred embodiment;

FIG. 10 is a fragmentary perspective view illustrating the third preferred embodiment in a state of use when a movable second frame portion is in a non-used position;

FIG. 11 is a perspective view illustrating the third preferred embodiment in the state of use when the second frame portion is in a used position;

FIG. 12 is a schematic side view illustrating the third preferred embodiment in the state of use when the second frame portion is in the used position;

FIG. 13 is a fragmentary perspective view illustrating the third preferred embodiment in the state of use when the movable frame portion is in the used position; and

FIG. 14 is a partly exploded fragmentary perspective view showing a float and a float-mounting frame of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

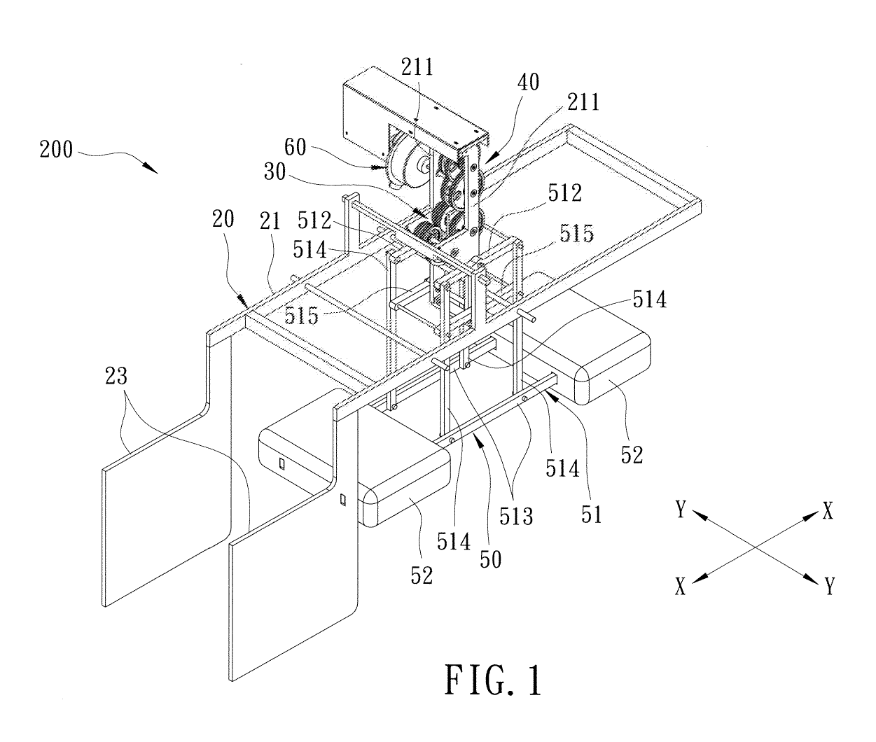

Referring to FIGS. 1 to 4, the first preferred embodiment of an apparatus 200 for generating electric power using water wave energy, such as ocean wave energy, according to the present invention is shown to include a frame unit 20, and an electric generating device.

In this embodiment, the frame unit 20 includes a main frame 21, and a pair of upright rudder plates 23. The main frame 21 has a pair of vertically extending mounting plates 211 opposite to each other in a first direction (Y). The rudder plates 23 are connected to one side of the main frame 21 and are spaced apart from each other in the first direction (Y). The rudder plates 23 extend in a second direction (X) transverse to the first direction (Y).

The electric generating device includes a float unit 50, a transmission unit 30, an accelerating unit 40, and a generator 60.

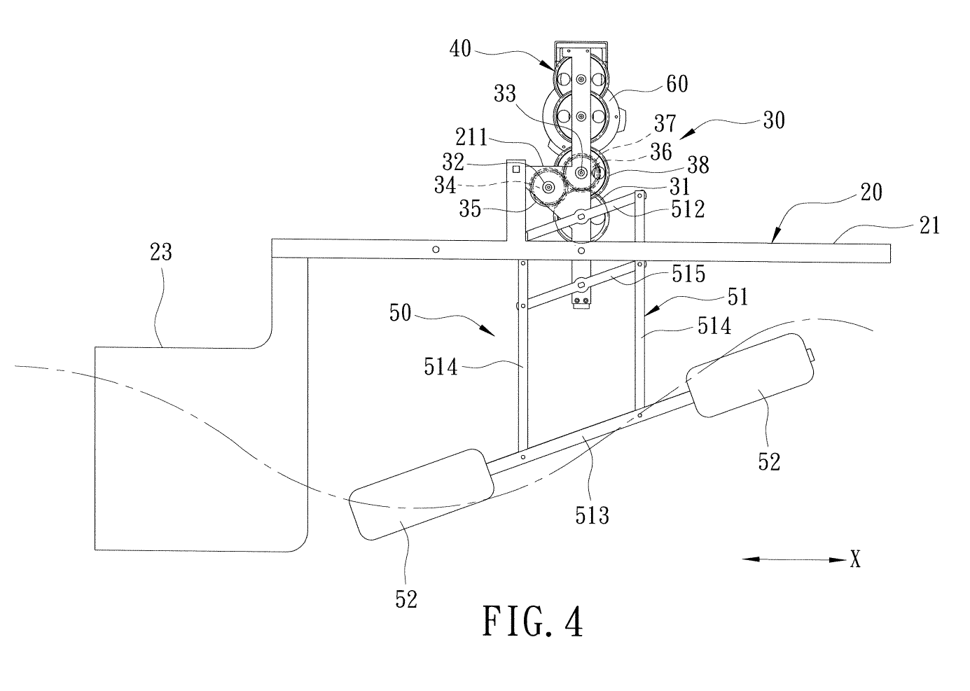

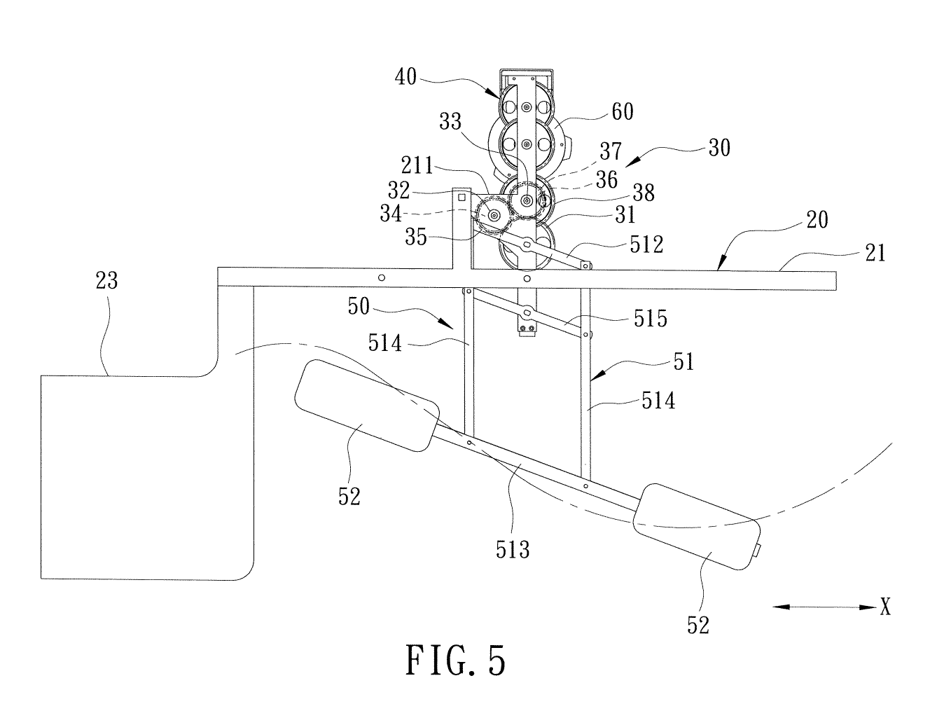

The float unit 50 is mounted pivotally on the main frame 21, and includes a float-mounting frame 51 and a pair of floats 52 opposite to each other in the second direction (X). In this embodiment, the float-mounting frame 51 includes a pivot rod 511 extending in the first direction (Y) through the mounting plates 211 of the main frame 21 and having opposite ends that are connected pivotally and respectively to the mounting plates 211 of the main frame 21. The float-mounting frame 51 further includes a pair of first connecting rods 512, a pair of second connecting rods 513, two pairs of vertically extending third connecting rods 514, and a pair of auxiliary connecting rods 515. The first connecting rods 512 are opposite to each other in the first direction (Y), and are connected fixedly and respectively to the opposite ends of the pivot rod 511. The second connecting rods 513 extend in the second direct ion (X), are opposite to each other in the first direction (Y), are disposed under the first connecting rods 512, and interconnect the floats 52. Each pair of the third connecting rods 514 is connected pivotally between a corresponding first connecting rod 512 and a corresponding second rod 513. The third connecting rods 514 of each pair are parallel to each other. Each auxiliary connecting rod 515 is connected pivotally between a corresponding pair of the third connecting rods 514, and is disposed parallel to the corresponding first and second rods 512, 513 and between a corresponding first connecting rod 512 and a corresponding second connecting rod 513. The floats 52 are adapted to ride on a water surface, such as an ocean surface, such that the frame unit 20 is supported by the float unit 50 to float on the water. In this case, the rudder plates 23 extend into the water (see FIG. 4). The pivot rod 511 is rotatable relative to the main frame 21 in response to water wave front action to generate a bidirectional mechanical rotary power output corresponding to water wave energy, as shown in FIGS. 4 and 5. It is noted that, due to the presence of the rudder plates 23, the frame unit 20 is guided so that the second direction (Y) is identical to the wave propagation direction.

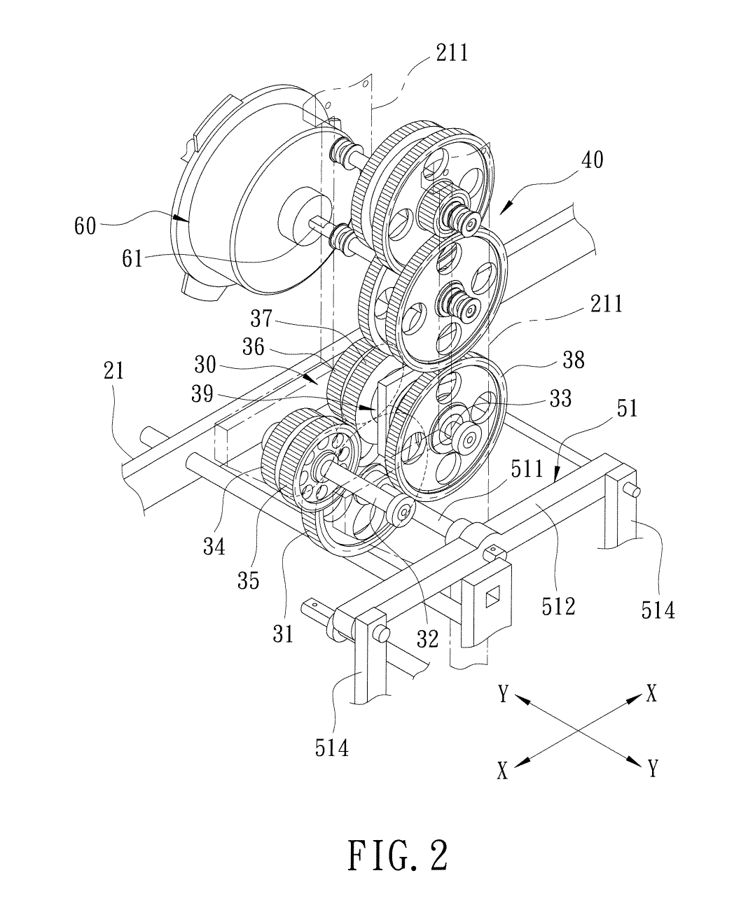

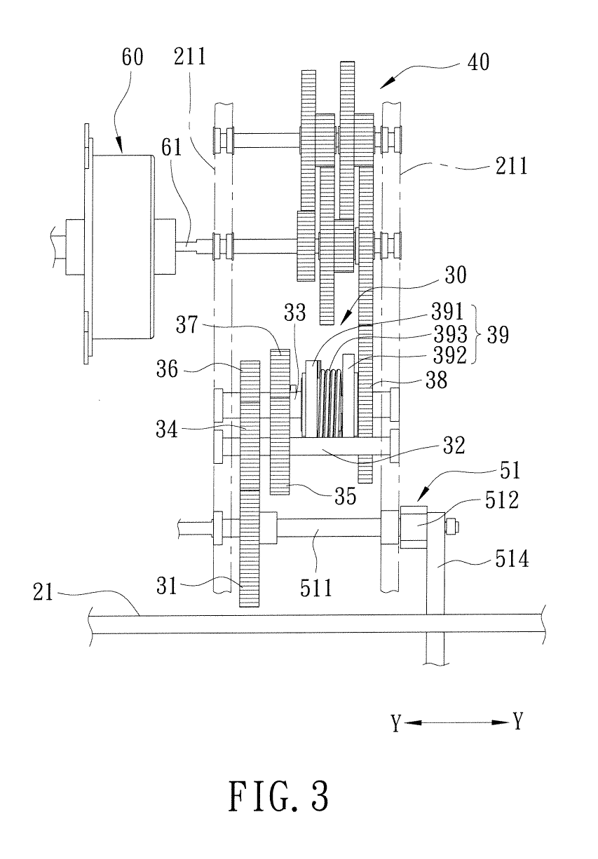

As shown in FIGS. 2 and 3, the transmission unit 30 is mounted on the mounting plates 211 of the main frame 21, and is coupled to the pivot rod 511 of the float-mounting frame 51 of the float unit 50. The transmission unit 30 receives the bidirectional mechanical rotary power output generated by the pivot rod 511, and outputs a single directional mechanical rotary power output based on the bidirectional mechanical rotary power output received thereby. In this embodiment, the transmission unit 30 includes a driving gear 31, first and second axle rods 32, 33, first, second, third and fourth transmission gears 34, 35, 36, 37, a driven gear 38, and a speed-buffering member 39.

The driving gear 31 is disposed co-axially on and is rotatable with the pivot rod 511 of the float-mounting frame 51.

The first and second axle rods 32, 33 are connected pivotally between the mounting plates 211 of the main frame 21, and extend in the first direction (Y).

The first and second transmission gears 34, 35 are disposed co-axially on the first axle rod 32. The third and fourth transmission gears 36, 37 are disposed co-axially on the second axle rod 33. The first and third transmission gears 34, 36 mesh with the driving gear 31, and the second and fourth transmission gears 35, 37 mesh with each other so that the second axle rod 33 is rotatable with one of the third and fourth transmission gears 36, 37 in a third direction, for example, a clockwise direction or a counterclockwise direction, in response to rotation of said driving gear 31. It is noted that the third transmission gear 36 is a first one-way gear that permits the second axle rod 33 to co-rotate therewith in the third direction in response to bidirectional rotation of the driving gear 31, and that One of the first, second and fourth transmission gears 34, 35, 37 is a second one-way gear. In this embodiment, the fourth transmission gear 37 is the second one-way gear that permits the second axle rod 33 to co-rotate therewith in the third direction in response to rotation of the driving gear 31. In other embodiments, the first transmission gear 34 is the second one-way gear that permits the first axle rod 32 to co-rotate therewith in a direction opposite to the third direction, such as a counterclockwise direction or a clockwise direction, in response to rotation of the driving gear 31. Alternatively, the second transmission gear 35 is the second one-way gear that is driven by the first axle rod 32 to rotate in the direction opposite to the third direction in response to rotation of the driving gear 31.

The driven gear 38 is sleeved co-axially on the second axle rod 33. The speed-buffering member 39 is mounted on and is rotatable with the second axle rod 33. The speed-buffering member 39 is connected to the driven gear 38 for driving the driven gear 38 to rotate about the second axle rod 33 in the third direction in response to rotation of the second axle rod 33 and for buffering the rotational speed difference between the second axle rod 33 and the driven gear 38. As a result, the driven gear 38 outputs the transmitted mechanical rotary output that corresponds to a rotational speed of the driven gear 38. In this embodiment, as shown FIG. 3, the speed-buffering member 39 includes first and second connecting blocks 391, 392, and a resilient piece 393. The first connecting block 391 is mounted on and is rotatable with the second axle rod 33. The second connecting block 392 is spaced apart from the first connecting block 391 in the first direction (Y), is sleeved around the second axle rod 33, and is connected to the driven gear 38. The resilient piece 393, such as a spring, is disposed around the second axle rod 33, and is connected between the first and second connecting blocks 391, 392 for buffering the rotational speed of the driven gear 38.

The generator 60 is mounted on the main frame 21 and has a drive shaft 61.

The accelerating unit 40 is mounted on the mounting plates 211 of the main frame 21, and is coupled between the transmission unit 30 and the drive shaft 61 of the generator 60. The accelerating unit 40 receives the single directional mechanical rotary power output from the transmission unit 30 to accelerate a rotational speed of the drive shaft 61 of the generator 60 such that the generator 60 converts rotary power corresponding to the rotational speed of the drive shaft 61 into electric power. In this embodiment, the accelerating unit 40 includes a transmission gear set that is in the form of a gear box and that consists of a plurality of transmission gears with different sizes, one of which meshes the driven gear 38 of the transmission unit 30, and another one of which is disposed co-axially and fixedly on the drive shaft 61 of the generator 60.

In sum, when waves move up and down, the generator 60 can continuously generate electric power based on clockwise or counterclockwise rotation of the pivot rod 511. Therefore, the apparatus 200 of the present invention has a high electric generation efficiency. Furthermore, since the frame unit 20 can freely float on the water, the apparatus 200 of the present invention can be used in a deep-water area of the sea.

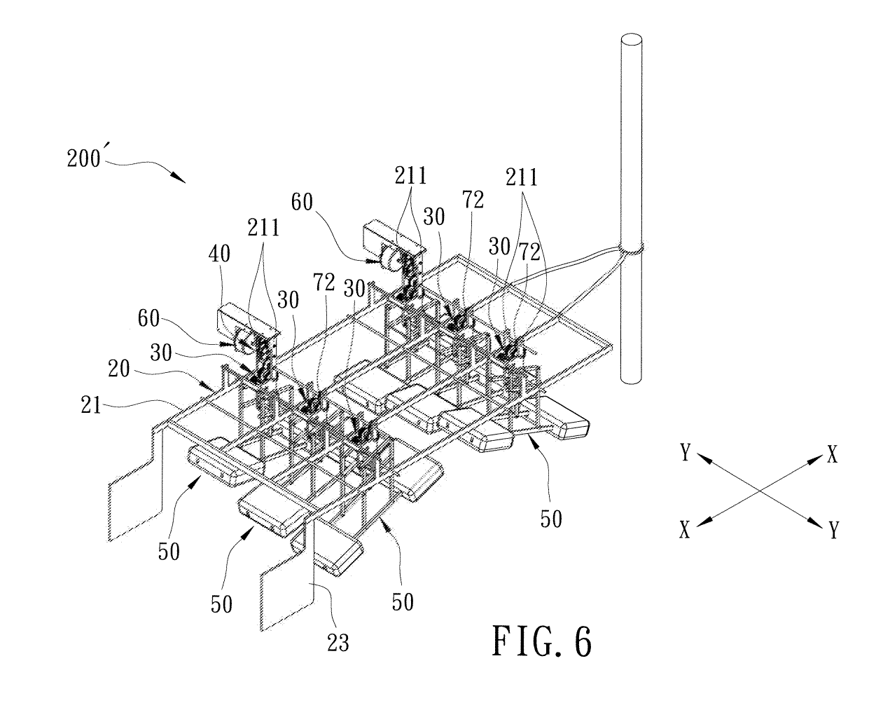

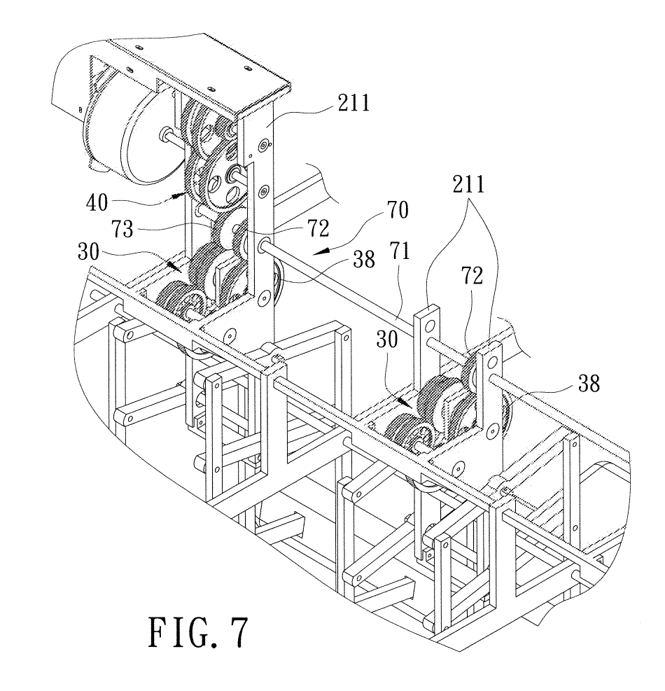

FIGS. 6 and 7 illustrate the second preferred, embodiment of an apparatus 200′ for generating electric power using water wave energy according to this invention, which is a modification of the first preferred embodiment. In this embodiment, the apparatus 200′ includes a pair of the electric generating devices mounted on the main frame 21 of the frame unit 20 and opposite to each other in the second direction (X). In other embodiments, the number of the electric generating devices is not limited to two.

The main frame 21 includes a plurality of pairs of the mounting plates 211 for the electric generating devices.

In this embodiment, each electric generating device includes three float units 50 arranged in the first direction (Y) and connected pivotally and respectively to the pairs of the mounting plates 211, and three transmission units 30 corresponding respectively to the float units 50. In other embodiments, the number of the float units 50 is not limited to three. Each electric generating device further includes an auxiliary transmission unit 70 mounted on the main frame 21 and coupled among the transmission units 30 and the accelerating unit 40 for receiving the single directional mechanical rotary power output from each of the transmission units 30 and for transmitting the single directional mechanical rotary power output received thereby to the accelerating unit 40.

In this embodiment, the auxiliary transmission unit 70 includes a transmission rod 71, three first one-way gears 72, and a second gear 73. The transmission rod 71 extends through the mounting plates 211 of the main frame 21 in the first direction (Y), and is mounted rotatably on the main frame 21. The first one-way gears 72 are disposed co-axially on and are rotatable with the transmission rod 71. Each first one-way gear 72 meshes with the driven gear 38 of a corresponding one of the transmission units 30 such that the transmission rod 71 is rotatable in response to the single directional mechanical rotary power output from any one of the transmission units 30. The second gear 73 is disposed co-axially on and is rotatable with the transmission rod 71, and meshes with the transmission gear set of the accelerating unit 40. It is noted that the auxiliary transmission unit 70 further includes a plurality of one-way bearings (not shown) sleeved on the transmission rod 71. Each one-way bearing is disposed between the transmission rod 71 and a corresponding first one-way gear 72 to permit the transmission rod 71 to rotate with the corresponding first one-way gear 72 in a fourth direction opposite to the third direction, such as a counterclockwise direction or a clockwise direction. Thus, even though one transmission unit 30 or one float unit 50 malfunctions, the auxiliary transmission unit 70 can still transmit the single directional mechanical rotary power outputs from the other transmission units 30 to the accelerating unit 40.

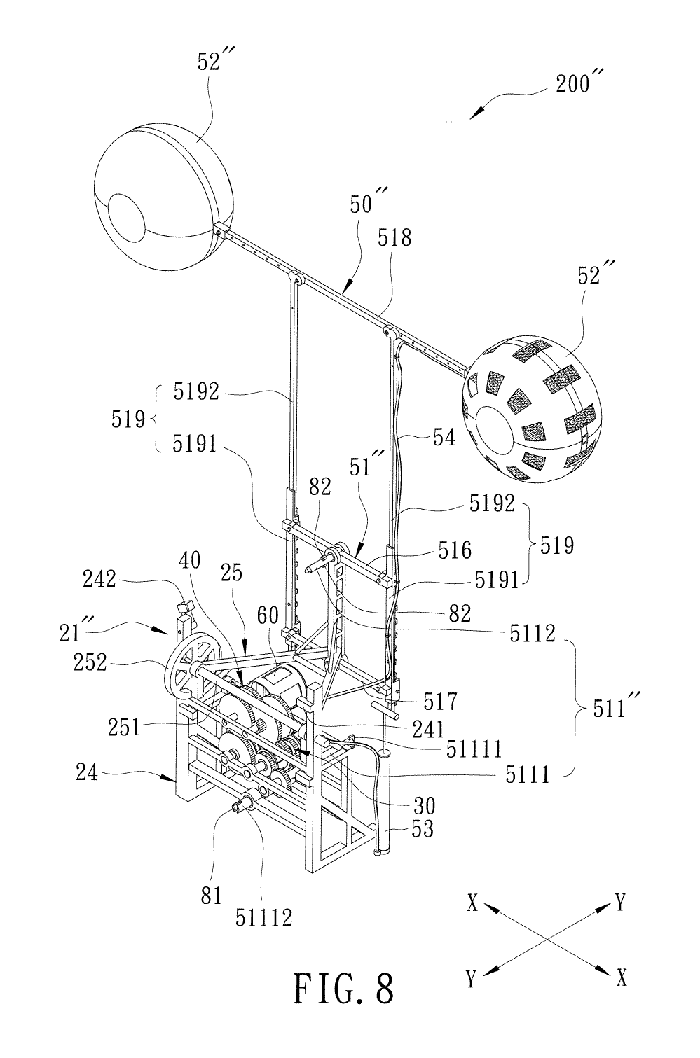

FIGS. 8 to 14 illustrate the third preferred embodiment of an apparatus 200″ for generating electric power using water wave energy according to this invention, which is a modification of the first preferred embodiment. In this embodiment, the rudder plates 23 in the first preferred embodiment are omitted.

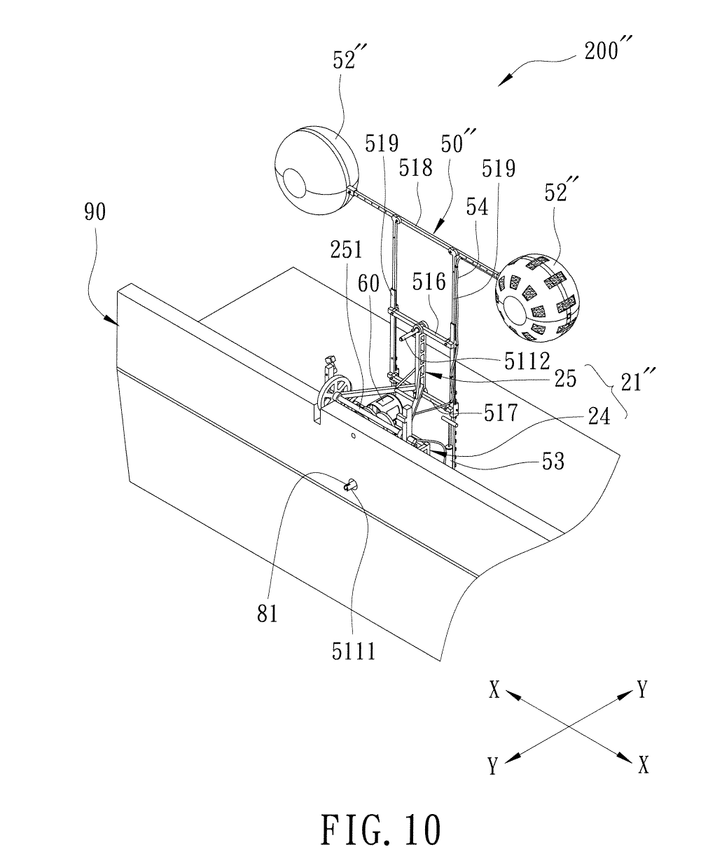

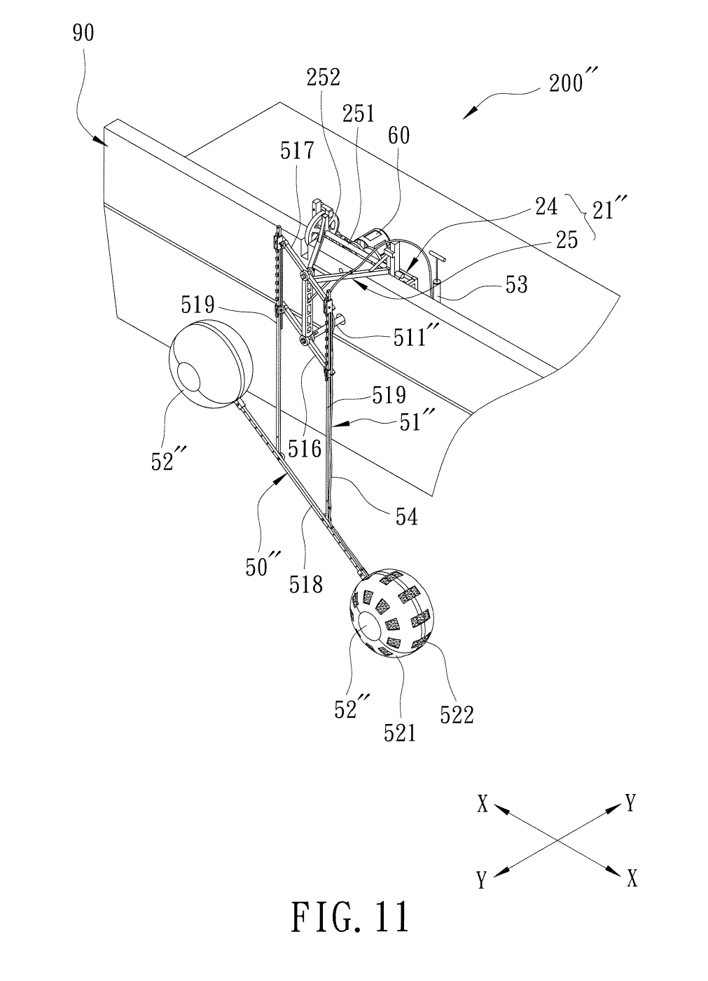

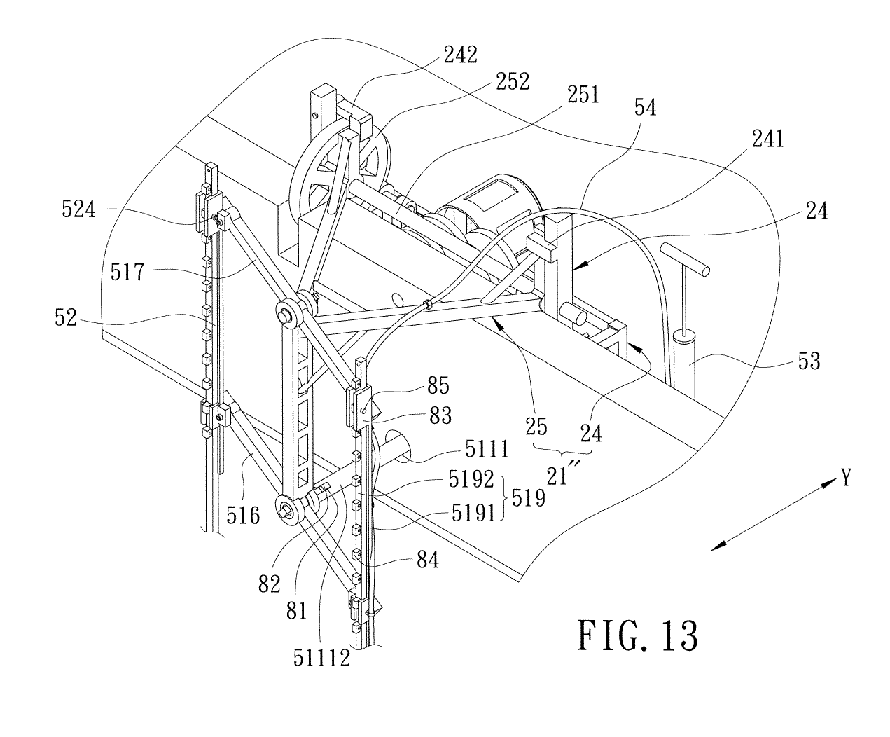

In this embodiment, the main frame 21″ is adapted to be mounted on the side of a ship 90 (see FIG. 10). The main frame 21″ includes a stationary first frame portion 24 and a movable second frame portion 25. The first frame portion 24 is adapted to be mounted on the side of the ship 90, and is provided with the transmission unit 30, the accelerating unit 40 and the generator 60 thereon. The second frame portion 25 is connected pivotally to the first frame portion 24 such that the second frame portion 25 is rotatable relative to the first frame portion 24 between a used position, where the second frame portion 25 is hung on the side of the ship 90, as shown in FIG. 11, and a non-used position, where the second frame portion 25 is disposed above the ship 90, as shown in FIG. 10. In this embodiment, the second frame portion 25 includes a rod 251 extending in the second direction (X) and mounted pivotally on the first frame portion 24, and a handle wheel 252 disposed co-axially and integrally on the rod 251. The handle wheel 252 is operable to move the second frame portion 25 between the used position and the non-used position. In addition, the first frame portion 24 further includes a pivotable positioning block 242 that is operable to engage releasably the handle wheel 252 of the second frame portion 25 when the second frame portion 25 is at the used position, as best shown in FIG. 13, thereby positioning the second frame portion 25 in the used position.

In this embodiment, the float-mounting frame 51″ of the float unit 50″ includes the pivot rod 511″, a first connecting rod 516, a second connecting rod 517, a third connecting rod 518, and a pair of fourth connecting rods 519.

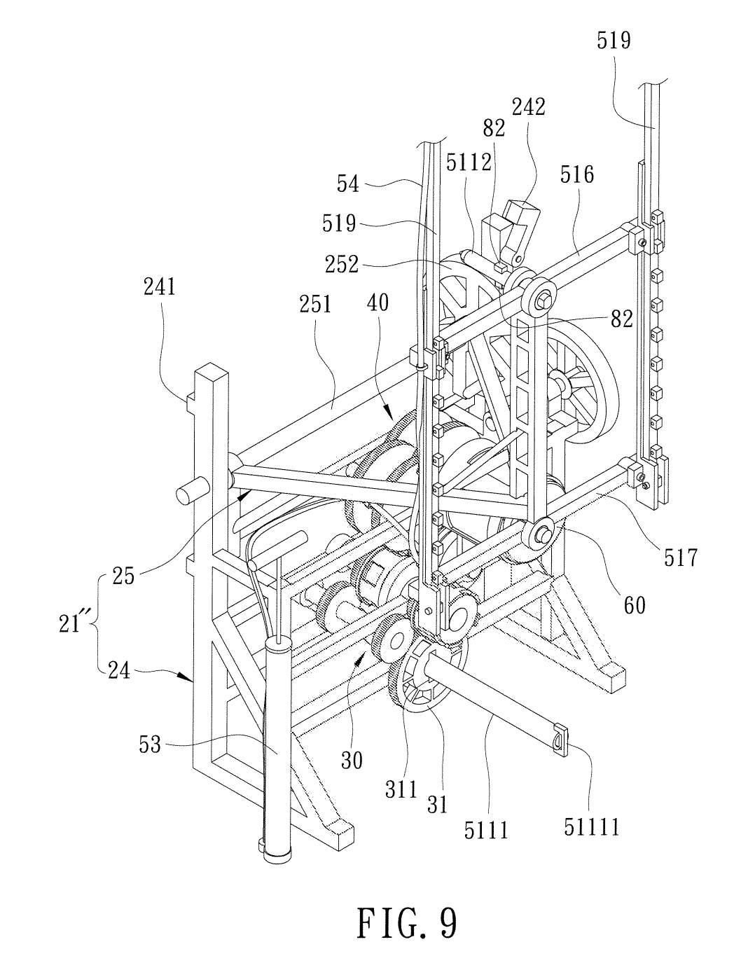

The pivot rod 511″ has a first rod portion 5111 and a second rod portion 5112. The first rod portion 5111 is movable relative to the first frame portion 24 of the main frame 21″ in the first direction (Y), is connected pivotally to the first frame portion 24 of the main frame 21″, and is adapted to extend outwardly of the ship 90. In addition, the first rod portion 5111 is provided with the driving gear 31 of the transmission unit 30 thereon. In this embodiment, the driving gear 31 is formed with a central engaging hole 311 permitting extension of the first rod portion 5111 therethrough, as best shown in FIG. 9, such that the first rod portion 5111 is movable relative to the driving gear 31 in the first direction (Y). The first rod portion 5111 has an enlarged operating end 51111, and a tubular connecting end 51112 opposite to the operating end 51111 in the first direction (Y) and disposed outwardly of the ship 90. When the operating end 51111 of the first rod portion 5111 is moved toward the driving gear 31 to engage the central engaging hole 311 in the driving gear 31, the driving gear 31 is rotatable with the first rod portion 5111. The connecting end 51112 of the first rod portion 5111 is formed with opposite engaging slots 81. The second rod portion 5112 is mounted pivotally on the second frame portion 25 of the main frame 21″, and has opposite radially extending engaging blocks 82. When the second frame portion 25 of the main frame 21″ is at the used position, the first rod portion 5111 of the pivot rod 511″ is operable to connect detachably the second rod portion 5112 through engagement between the engaging slots 81 in the connecting end 51112 of the first rod portion 5111 and the engaging blocks 82 of the second rod portion 5112, so that an assembly of the first and second rod portions 5111, 5112 extends in the first direction (Y) (see FIG. 13).

The first connecting rod 516 is transverse to and is connected fixedly to the second rod portion 5112 of the pivot rod 511″, and is mounted pivotally on the second frame portion 25 of the main frame 21″.

The second connecting rod 517 is spaced vertically apart from the first connecting rod 516, and is mounted pivotally on the second frame portion 25 of the main frame 21″.

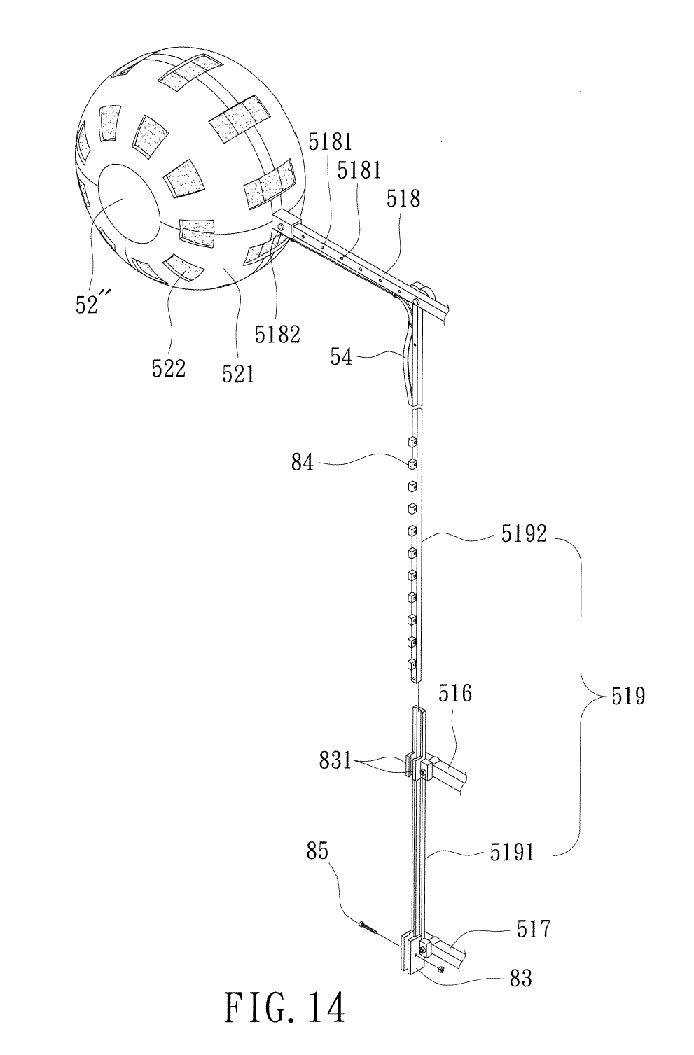

The third connecting rod 518 is spaced vertically apart from the first connecting rod 516 such that the first connecting rod 516 is disposed between the second and third connecting rods 517, 518. The third connecting rod 518 interconnects the floats 52″. In addition, the third connecting rod 518 is formed with a plurality of positioning holes 5181, and a pair of positioning bolts 5182. Each positioning bolt 5182 extends through a corresponding float 52″ and a desired positioning hole such that the corresponding float 52″ is connected to the third connecting rod 518, as best shown in FIG. 14. Due to the presence of the positioning holes 5181, a desired distance between the floats 52″ can be formed.

The fourth connecting rods 519 are opposite to each other in the second direction (X). Each fourth connecting rod 519 is connected pivotally to the first, second and third connecting rods 516, 517, 518 such that the first, second and third connecting rods 516, 517, 518 are parallel to each other. In addition, each fourth connecting rod 519 is adjustable to have a desired length corresponding to the size of the ship 90 so that the floats 52″ are capable of riding on the water surface. In this embodiment, as shown in FIG. 14, each fourth connecting rod 519 includes a first rod piece 5191 and a second rod piece 5192. For each fourth connecting rod 519, the first rod piece 5191 is connected pivotally to the first and second connecting rods 516, 517, and has a first connecting seat 83. The second rod piece 5192 is connected pivotally to the third connecting rod 518, and has a plurality of spaced apart second connecting seats 84. A screw fastener 85 extends through a desired second connecting seat 84 of the second rod piece 5192 and the first connecting seat 83 of the first rod piece 5191 for fastening the second rod piece 5192 to the first rod piece 5191 such that the desired length of the fourth connecting rods 519 can be decided. In addition, for each the fourth connecting rod 519, the first rod piece 5191 is formed with a pair of clamping plates 831 for clamping slidably the second rod piece 5192 therebetween.

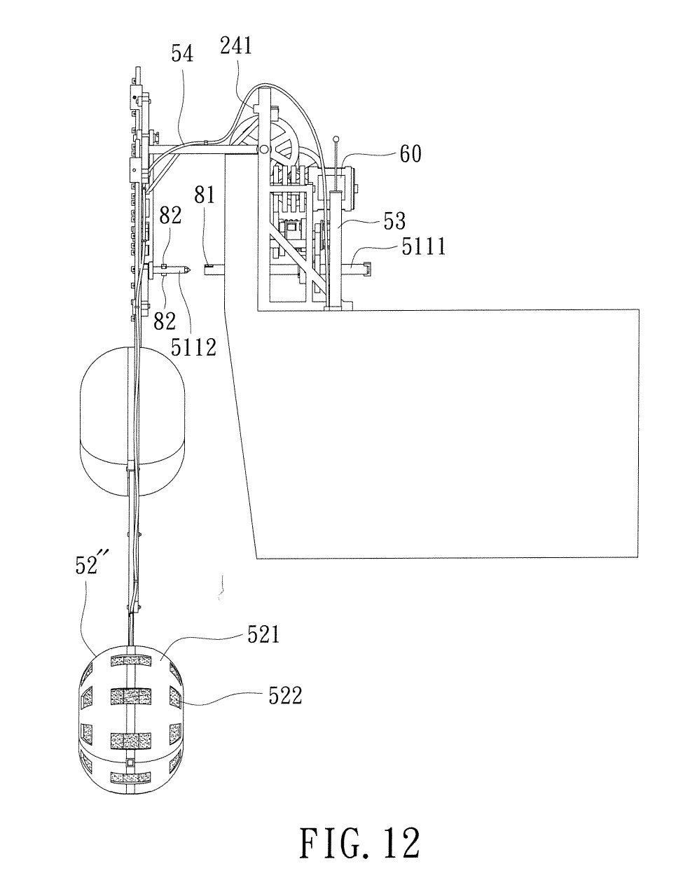

In this embodiment, as shown in FIG. 12, one float 52″ has a hollow housing 521 formed with a plurality of openings, and an air bag 522 disposed in the housing 521. The float unit further includes an air pump 53, and a gas pipe 54 connected between the air bag 522 and the air pump 53. The air pump 53 is operable to pump gas into or out of the air bag 522 through the gas pipe 54. In use, the air pump 53 is preferably operated to pump gas out of the air bag 522 before the second frame portion 25 is moved to the used position. As a result, when the second frame portion 25 is moved to the used position, the housings 521 of said one float 52″ easily dips into the water due to minimized floating power of the air bag 522. Then, the air pump 53 is operated to pump gas into the air bag 522 to enable said float 52″ to float on the water.

In such a configuration, the apparatus 200″ of the present invention is also applicable to a moving ship.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An apparatus for generating electric power using water wave energy, said apparatus comprising:
a frame unit including a main frame; and
at least one electric generating device mounted on said main frame of said frame unit, said electric generating device including
at least one float unit mounted pivotally on said main frame, and including
a float-mounting frame including a pivot rod connected pivotally to said main frame and extending in a first direction, and
a pair of floats opposite to each other in a second direction transverse to the first direction, connected to the float-mounting frame, and adapted to ride on a water surface such that said pivot rod is rotatable relative to said main frame in response to water wave front action to generate a bidirectional mechanical rotary power output corresponding to water wave energy,
at least one transmission unit mounted on said main frame, coupled to said pivot rod, receiving the bidirectional mechanical rotary power output generated by said pivot rod, and outputting a single directional mechanical rotary power output based on the bidirectional mechanical rotary power output received thereby,
a generator mounted on said main frame and having a drive shaft, and
an accelerating unit mounted on said main frame and coupled between said transmission unit and said drive shaft of said generator, said accelerating unit receiving the single directional mechanical rotary power output from said transmission unit to accelerate a rotational speed of said drive shaft of said generator such that said generator converts rotary power corresponding to the rotational speed of said drive shaft into electric power.

2. The apparatus as claimed in claim 1, wherein said frame unit further includes at least one upright rudder plate connected to said main frame and adapted to extend into the water.

3. The apparatus as claimed in claim 1, wherein said transmission unit includes:
a driving gear disposed co-axially on and rotatable with said pivot rod of said float-mounting frame;
first and second axle rods connected pivotally to said main frame and extending in the first direction, first and second transmission gears disposed co-axially on said first axle rod, and third and fourth transmission gears disposed co-axially on said second axle rod, said first and third transmission gears meshing with said driving gear, and said second and fourth transmission gears meshing with each other so that said second axle rod is rotatable with one of said third and fourth transmission gears in a third direction in response to rotation of said driving gear;
a driven gear driven to rotate about said second axle rod in the third direction response to rotation of said second axle rod, said driven gear being coupled to said accelerating unit such that the single directional mechanical rotary power output corresponding to a rotational speed of said driven gear is output to said acceleration unit; and
a speed-buffering member for driving rotation of said driven gear and for buffering the rotational speed difference between said second axle rod and said driven gear.

4. The apparatus as claimed in claim 3, wherein said driven gear is sleeved co-axially on said second axle rod, and said speed-buffering member is connected to said second axle rod and said driven gar.

5. The apparatus as claimed in claim 3, wherein said accelerating unit includes a transmission gear set coupled between said driven gear and said drive shaft of said generator for accelerating the rotational speed of said drive shaft of said generator based on rotation of said driven gear of said transmission unit.

6. The apparatus as claimed in claim 3, wherein said speed-buffering member includes a first connecting block rotatable in response to rotation of said second axle rod, a second connecting block spaced apart from said first connecting block in the first direction, sleeved around said second axle rod and connected to said driven gear, and a resilient piece disposed around said second axle rod and connected between said first and second connecting blocks.

7. The apparatus as claimed in claim 3, wherein:
said electric generating device includes a plurality of said float units, and a plurality of said transmission units corresponding respectively to said float units; and
said electric generating device further includes an auxiliary transmission unit mounted on said main frame and coupled among said transmission units and said accelerating unit for receiving the signal directional mechanical rotary power output from each of said transmission units and for transmitting the single directional mechanical rotary power output received thereby to said accelerating unit.

8. The apparatus as claimed in claim 7, wherein said auxiliary transmission unit includes:
a transmission rod mounted rotatably on said main frame;
a plurality of first gears disposed co-axially on and rotatable with said transmission rod, each of said first gears meshing with said driven gear of a corresponding one of said transmission units such that said transmission rod is rotatable in response to the single directional mechanical rotary power output from any one of said transmission units; and
a second gear disposed co-axially on and rotatable with said transmission rod, and meshing with said transmission gear set of said accelerating unit.

9. The apparatus as claimed in claim 8, wherein each of said first gears is a one-way gear.

10. The apparatus as claimed in claim 3, wherein:
said third transmission gear is a first one-way gear that permits said second axle rod to co-rotate therewith in the third direction, and one of said first, second and fourth transmission gears is a second one-way gear;
when said first transmission gear is said second one-way gear, said second one-way gear permits said first axle rod to co-rotate therewith in a direction opposite to the third direction;
when said second transmission gear is said second one-way gear, said second one-way gear is driven by said second axle rod to rotate in the direction opposite to the third direction; and
when said fourth transmission gear is the second one-way gear, said second one-way gear permits said second axle rod to co-rotate therewith in the third direction.

11. The apparatus as claimed in claim 1, wherein said float-mounting frame of said float unit further includes:
a pair of first connecting rods opposite to each other in the first direction and connected fixedly and respectively to opposite ends of said pivot rod;
a pair of second connecting rods opposite to each other in the first direction, disposed under said first connecting rods, and interconnecting said floats; and
two pairs of third connecting rods, each pair of said third connecting rods being connected pivotally between a corresponding one of said first connecting rods, and a corresponding one of said second connecting rods, said third connecting rods of each pair being parallel to each other.

12. The apparatus as claimed in claim 1, wherein:
said main frame includes
a stationary first frame portion adapted to be mounted on a ship, and provided with said transmission unit, said accelerating unit and said generator thereon, and
a movable second frame portion connected pivotally to said first frame portion such that said second frame portion is rotatable relative to said first frame portion between a used position and a non-used position;
said pivot rod of said float-mounting frame of said float unit has
a first rod portion movable relative to said first frame portion of said main frame in the first direction, connected pivotally to said first frame portion of said main frame, provided with said driving gear of said transmission unit thereon, and adapted to extend outwardly of the ship, and
a second rod portion mounted pivotally on said second frame portion of said main frame;
when said second frame portion of said main frame is at the used position, said first rod portion of said pivot rod is operable to connect detachably said second rod portion so that an assembly of said first and second rod portions extends in the first direction; and
when said second frame portion of said main frame is at the non-used position, said first and second portions of said pivot rod are separated from each other.

13. The apparatus as claimed in claim 12, wherein said float-mounting frame of said float unit further includes:
a first connecting rod transverse to and connected fixedly to said second rod portion of said pivot rod, and mounted pivotally on said second frame portion of said main frame;
a second connecting rod spaced vertically apart from said first connecting rod and mounted pivotally on said second frame portion of said main frame;
a third connecting rod spaced vertically apart from said first connecting rod, and interconnecting said floats; and
a pair of fourth connecting rods opposite to each other in the second direction, each of said fourth connecting rods being connected pivotally to said first, second and third connecting rods.

14. The apparatus as claimed in claim 13, wherein each of said fourth connecting rods is adjustable to have a desired length so that said floats are capable of riding on the water surface.

15. The apparatus as claimed in claim 13, wherein said floats are adjustable to form a desired distance therebetween.

16. The apparatus as claimed in claim 12, wherein one of said floats of said float unit has a hollow housing, and an air bag disposed in said hollow housing.

17. The apparatus as claimed in claim 16, wherein said float unit further includes an air pump, and a gas pipe connected between said air bag and said air pump, said air pump being operable to pump gas into or out of said air bag through said gas pipe.

18. The apparatus as claimed in claim 1, wherein:
said electric generating device includes a plurality of said float units, and a plurality of said transmission units corresponding respectively to said float units; and
said electric generating device further includes an auxiliary transmission unit mounted on said main frame and coupled among said transmission units and said accelerating unit for receiving the single directional mechanical rotary power output from each of said transmission units and for transmitting the single directional mechanical rotary power output received thereby to said accelerating unit.
